(19) United States
(12) Patent Application Publication
(10) Pub. No.: US 2020/0371227 A1
(43) Pub. Date: Nov. 26, 2020

(54) BODY-MOUNTED THREAT DETECTION SYSTEM AND METHODS OF USING SAME

(71) Applicant: First Responder Technologies Inc., Vancouver (CA)

(72) Inventor: Kulwant Malhi, Delta (CA)

(21) Appl. No.: 16/958,637

(22) PCT Filed: Dec. 28, 2018
(86) PCT No.: PCT/CA2018/051680

§ 371 Date: Jun. 26, 2020

Related U.S. Application Data
(60) Provisional application No. 62/611,902, filed on Dec. 29, 2017.

(51) Int. Cl. G01S 13/88; G01S 7/41

(52) U.S. Cl. CPC G01S 13/887; G01S 7/412

(57) ABSTRACT

Body-mounted threat detection systems and methods of detecting threats using body-mounted threat detection systems are provided. Threats detected include guns, knives and/or explosives. A body-mounted transmitter directs electromagnetic radiation towards the target and a body-mounted receiver receives electromagnetic radiation returned from the target. The return signal is analyzed and a signal indicative of the presence or absence of a threat is generated.

### REFERENCE TO RELATED APPLICATIONS

This application claims priority to, and the benefit of, U.S. provisional patent application No. 62/611,902 filed 29 Dec. 2017, the entirety of which is incorporated by reference herein for all purposes.

### TECHNICAL FIELD

Some embodiments of this invention relate to apparatus and methods for detecting threats such as weapons or explosives carried on a person. Some embodiments of this invention relate to apparatus that can be worn on a first person's body in order to detect threats such as weapons or explosives carried on a second person.

### BACKGROUND

Preventing unauthorized persons from carrying weapons is an extremely important objective. There are a considerable number of terrorist and other mass attacks on the public that are carried out using weapons such as guns and explosive devices. There is also concern for the safety of police officers and other first responders when dealing with persons who are potentially armed. There is also a concern to ensure that law enforcement officials do not overreact, for example by causing bodily harm to an individual they fear may be carrying a weapon but who in actual fact is not carrying a weapon.

Methods of remotely detecting weapons, explosives, and undesired objects have been developed using a number of different techniques. Conventional detection techniques, such as those commonly employed in airports and at other screening points, typically require close proximity to a target person or suspect, and generally require the cooperation of the target person or suspect.

For example and without limitation, persons may need to individually walk through a controlled detection point, e.g. a metal detector or the like, in order to be scanned. Persons who do not pass through the controlled detection point cannot be scanned, making such systems impractical for field use. Also, such systems may not be able to distinguish between objects that pose a threat to others, e.g. a gun, knife or explosive, and non-harmful objects such as belt buckles, jewelry, coins, cell phones, and the like.

Whole-body scanners have been developed to use millimetre-wave frequency ranges (e.g. between 30 GHz and 300 GHz) to allow visual identification of threat objects carried by a person, but require an inspected person to stand stationary with arms raised and legs spread apart to allow an image of the entirety of a person's body to be taken. Whole-body scanners also produce such a detailed image of a person's body that privacy concerns arise with their use.

More recently, stand-off techniques for detecting concealed weapons or other items of interest at a distance without generating an image of the target person have been developed. Some such techniques use a fast pulse of electromagnetic energy and measure the response (or reflected electromagnetic energy) as a function of time, as is done with conventional radar technology. This technique can also be used to detect dielectric layers such as may be found in explosives.

Some stand-off weapons detection techniques make use of the natural resonance of the human body in response to the application of appropriate electromagnetic signals. For example, U.S. Pat. No. 8,188,862 describes an apparatus for remotely detecting metal objects carried by a person. A first electromagnetic signal is emitted to a person at a frequency known to be resonant with the human body. Response signal energy is received by an antenna, and processing circuitry is used to determine whether the response signal energy is indicative of whether or not the person is carrying an appreciable amount of metal, based on reference response templates for persons that are known to be metal free.

Patent Cooperation Treaty patent application publication No. WO 2009/115818 discloses methods of using electromagnetic waves for detecting metal and/or dielectric objects. Microwave and/or millimetre wave radiation is directed from a transmission apparatus and is received using a detection apparatus. One or more detection signals are generated in the frequency domain using the detection apparatus. The transmitted radiation may be swept over a predetermined range of frequencies, a transform operation may be performed on the detection signal(s) to generate one or more transformed signals in the time domain and one or more features of the transformed signal may be used to determine one or more dimensions of a metallic or dielectric object upon which the transmitted radiation is incident. A system and method for remote detection and/or identification of a metallic threat object using late time response (LTR) signals is also disclosed.

US patent application publication No. 2015/0379356 describes a system and method for detecting weapons in which a radiofrequency transmitter transmits an RF signal stream into a region of interest. An RF receiver receives a scattered signal stream from the region of interest. A plurality of resonant signal components are identified from the scattered signal stream. Preprocessed resonant signal components are generated by removing environmental signal components. A target assessment is determined from the preprocessed resonant signal components using a trained statistical model.

Body-mounted antenna systems have been developed, for example as described in Patent Cooperation Treaty patent application publication No. WO 2016/198820, U.S. Pat. No. 9,564,682, and others. Such systems can be integrated into clothing worn by a user, e.g. a tactical vest, to facilitate radio communications.

Each of the patents, and patent application publications mentioned above is incorporated by reference herein for all purposes.

There is a general desire for improved systems and methods for detecting threats such as weapons and bombs at a distance from a target person or suspect. There is a general desire for such systems that are portable, including those that can be worn on the body of a person and deployed for field use.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one aspect, a body-mounted threat detection system for detecting threat objects on a target is provided, having a body-mounted transmitter for directing electromagnetic radiation towards the target. The system has a body-mounted receiver for receiving electromagnetic radiation returned from the target as a return signal, a database containing a plurality of predetermined threat templates representing return signals for a plurality of different known threat items, a processor adapted to analyze the return signal by comparing the return signal with the plurality of predetermined threat templates, and a signal unit configured to output a threat indication if the processor determines that the return signal matches one or more of the predetermined threat templates. In some aspects, the database further contains a plurality of predetermined safe templates representing return signals for a plurality of known safe items, and the processor is further configured to analyze the return signal by comparing the return signal with the plurality of predetermined safe templates. The signal unit can be configured to output a safe indication in such circumstances.

In one aspect, a method of allowing a user to detect a threat object on a target includes transmitting electromagnetic radiation towards the target from a transmitter worn on the body of the user, receiving electromagnetic radiation returned from the target as a return signal using a receiver worn on the body of the user, comparing the return signal with a plurality of predetermined threat templates representing return signals for a plurality of different known threat items, and outputting to the user a threat indication if the return signal matches one or more of the predetermined threat templates. In some aspects, the return signal is further compared with a plurality of predetermined safe templates representing return signals for a plurality of different known safe items. In some aspects, a safe indication is outputted if the return signal matches one or more of the predetermined safe templates and none of the predetermined threat templates.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a method of remotely using a body-mounted threat detection system to detect a threat object on a target person.

FIG. 2 shows schematically an example embodiment of a body-mounted threat detection system.

FIG. 3 shows schematically a second example embodiment of a body-mounted threat detection system.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the term “stand-off threat detection system” means a threat detection system that can be used at a distance from a target person or suspect, to determine whether the target person or suspect is carrying a weapon, explosive, or other undesired item that can be used to cause harm to others.

As used herein, the term “body-mounted” refers to a system at least a portion of which can be mounted on the body of a user, leaving the user's hands free and not unreasonably limiting the user's mobility or ability to perceive his or her surroundings (e.g. not unreasonably impairing the field of view of the user).

As used herein, the term “threat” refers to the fact that a target person or suspect is or is likely carrying a weapon, explosive, or other undesired item that can be used to cause harm to others (referred to herein as a “threat object”).

As used herein, the term “threat object” includes weapons, explosives, or other items that are generally used to intentionally cause harm to other people. As used herein, the term “weapon” includes any object that can ordinarily be used to cause harm to others, including e.g. a gun or knife.

As used herein, the term “safe object” refers to an object that is of a type likely to be commonly carried by people and unlikely to be ordinarily used to cause significant harm to others, for example, keys, belt buckles, jewelry, coins, cellular telephones, and the like.

The inventor has now devised a stand-off threat detection system that can be worn on the body of a user using body-mounted antennas, to allow law enforcement personnel and other first responders to determine in the field and at a distance whether a target person or a suspect is likely carrying a weapon, explosive, or other threat object. In some embodiments, the target includes a non-human animal or mammal, e.g. an animal that has been trained to carry an explosive device or other threat object.

In some embodiments, the stand-off threat detection system comprises a body-worn threat detection unit with a built in computer that is preprogrammed with a plurality of predefined templates corresponding to safe targets and targets carrying threat objects, so that the built in computer can make a quick determination of whether one or more threat objects may be concealed on the target.

Some embodiments of the invention have particular application for use by law enforcement or military personnel involved in checking targets or suspects at mobile checkpoints, checking targets or suspects who have been stopped by the law enforcement officer or military personnel (e.g. during routine traffic stops, or when the target or suspect is travelling by foot, by bicycle, or using any other mode of transport), checking targets or suspects involved in a fight or altercation, including in a group fight or altercation, for possible weapons, checking targets or suspects believed to be members of a gang or other organized crime unit for weapons, and the like.

In some embodiments, the distance from the target person or suspect at which the body worn stand-off threat detection system can be used is between 1 m and 10 m, or between 1 m and 20 m, or between 1 m and 100 m, including any value or sub-range therebetween, e.g. 2, 3, 4, 5, 6, 7, 8, 9, 10, 11, 12, 13, 14, 15, 20, 25, 30, 35, 40, 45, 50, 55, 60, 65, 70, 75, 80, 85, 90 or 95 m.

Without being bound by theory, the human body interacts with electromagnetic radiation and resonates at certain frequencies. When a human is carrying a metallic object, the natural resonance of the human body interacts with the natural resonance of the metallic object to cause the human body to resonate at a modified frequency range.

This phenomenon can be exploited to allow for the remote detection of metallic objects on the human body by evaluating the changes in resonant frequency. Low power transmissions of electromagnetic radiation can be used to detect metal objects on people.

Further without being bound by theory, objects made of metal or containing a high dielectric constant non-conductive material cause backscattering of electromagnetic radiation directed towards the object. Certain objects, such as handguns, can produce unique spectral backscattering signals, which can be used to confirm the presence of such object on a person.

Further without being bound by theory, when a highly conductive object is illuminated by a pulse of microwave frequency electromagnetic radiation, surface currents are excited on that highly conductive object. After the initial pulse of microwave frequency electromagnetic radiation has passed the object, a portion of which may be scattered back in what is referred to as the early time response or ETR that comprises the initial reflectance, the surface currents oscillate in such a way as to give rise to re-radiation that carries an electromagnetic signature or resonance that is unique to the highly conductive object. The re-radiated electromagnetic signal is referred to as the late time response (LTR). In some embodiments the LTR is used and processed to evaluate whether a person is carrying a concealed weapon or other threat object. In some embodiments, the LTR produced by the presence of a threat object is not dependent on the position or orientation of the threat object. In some embodiments, both the ETR and the LTR is used and processed to evaluate whether a person is carrying a concealed weapon or other threat object.

In some embodiments, the reflection and/or re-radiation of electromagnetic radiation from a metal object illuminated by a pulse of electromagnetic radiation after the pulse of electromagnetic radiation has passed the object (collectively referred to herein as a “return signal”), can be used to identify a target that is carrying a threat object.

In some embodiments, the electromagnetic radiation is microwaves, i.e. electromagnetic waves having wavelengths in the centimeter to millimeter range. In some embodiments, the electromagnetic radiation is radio frequency (RF). In some embodiments, the electromagnetic radiation is in the VHF (very high frequency) band.

In some embodiments, the electromagnetic radiation has a frequency in the range of 300 MHz to 300 GHz, including any value or subrange therebetween, e.g. 500 MHz, 750 MHz, 1 GHz, 2 GHz, 5 GHz, 10 GHz, 20 GHz, 30 GHz, 40 GHz, 50 GHz, 75 GHz, 100 GHz, 125 GHz, 150 GHz, 175 GHz, 200 GHz, 225 GHz, 250 GHz, or 275 GHz.

In some embodiments, the electromagnetic radiation has a wavelength in the range of 0.1 cm to 100 cm, including any value or subrange therebetween, e.g. 0.2, 0.3, 0.4, 0.5, 1, 2, 5, 10, 15, 20, 25, 30, 35, 40, 45, 50, 55, 60, 65, 70, 75, 80, 85, 90 or 95 cm.

In some embodiments, the electromagnetic radiation used is polarized and/or the polarization properties of the reflected signals received from the target are used to aid in identifying any threat object that may be present on the target.

In some embodiments, the pulse of electromagnetic radiation that is used is a stepped frequency pulse of electromagnetic radiation. In some embodiments, the pulse of electromagnetic radiation that is used is a wide-band pulse of electromagnetic radiation.

The electromagnetic radiation that is used is selected to be at a level that is not harmful to people, to avoid triggering health and safety concerns with respect to the persons being examined.

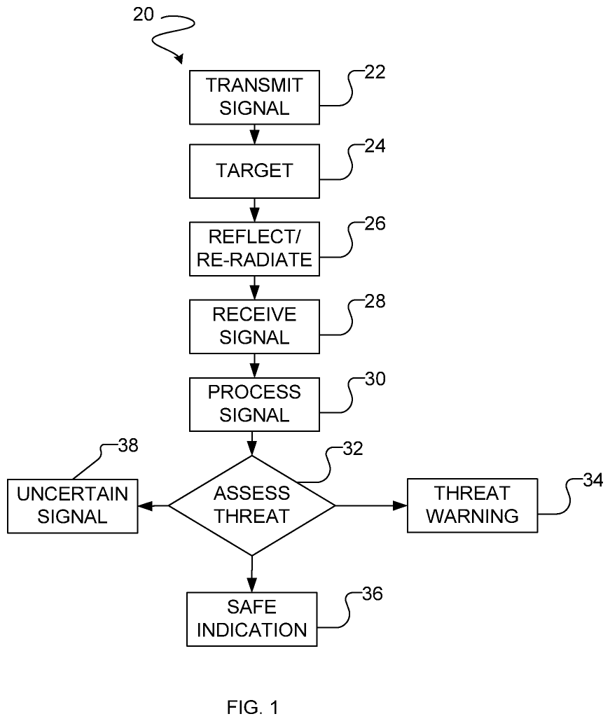

With reference to FIG. 1, an example embodiment of a method 20 of remotely detecting a threat object using a body-mounted threat detection system is shown schematically. At step 22, a body-mounted antenna is used to generate an electromagnetic signal directed towards a target. At step 24, the electromagnetic signal interacts with the target. At step 26, at least a portion of the electromagnetic signal is reflected and/or re-radiated from the target as a return signal. At step 28, a body-mounted antenna is used to receive the reflected and/or re-radiated electromagnetic signal (i.e. the return signal) from the target. At step 30, a signal processor examines the received reflected and/or re-radiated electromagnetic signal (i.e. the return signal) to determine whether the target represents a potential threat, e.g. whether the target is likely carrying a weapon, explosive material, or other undesirable threat item.

The signal processing conducted at step 30 can be carried out in any suitable manner. For example, in some embodiments, the reflected and/or re-radiated electromagnetic signal (i.e. the return signal) is compared to template signals obtained from targets either known to be free of weapons, explosives or other undesired devices or threat items, and including targets carrying safe objects, (referred to as “safe templates”), and/or template signals obtained from targets known to be carrying weapons, explosives or other threat objects (referred to as “threat templates”).

In some embodiments, a plurality of predefined threat templates are prepared using weapons, explosives or other undesired devices or threat objects in a plurality of different orientations and/or in a plurality of different locations on the human body. In some embodiments, a plurality of predefined safe templates are prepared using persons bearing no objects, or bearing safe objects such as belt buckles, coins, cellular telephones, keys and the like in a plurality of different orientations and/or in a plurality of different locations on the human body.

In some embodiments, a plurality of predefined threat templates and a plurality of predefined safe templates are produced wherein the target person is at a plurality of different distances from the body-mounted threat detection system. In some embodiments, the body-mounted threat detection system includes a distance determining system, e.g. a laser-based or sonic-based range finder, that measures the distance between the user of the body-mounted threat detection system and a target, so that the plurality of threat templates and the plurality of safe templates with which the reflected and/or re-radiated electromagnetic signal obtained from the target (i.e. the return signal) are compared correspond to targets located a similar distance from the body-mounted threat detection system.

In some embodiments, a plurality of predefined safe templates and a plurality of predefined threat templates are prepared and stored in a template library or database, so that the predefined threat and safe templates can be compared with the reflected and/or re-radiated electromagnetic signal (i.e. the return signal) obtained from the target.

In some embodiments, the signal processing conducted at step 30 compares the reflected and/or re-radiated electromagnetic signal (i.e. the return signal) from the target with a reflected and/or re-radiated electromagnetic signal (i.e. the return signal) obtained from the region occupied by the target without the target present (referred to as a “background template”). In some embodiments, the background template is subtracted from the signal reflected and/or re-radiated from the target (i.e. the return signal) prior to comparing the reflected and/or re-radiated signal obtained from the target with the plurality of safe templates and/or threat templates.

In some embodiments, because the method is carried out on the fly in the field with a target already present in the region of interest, it is not possible to obtain a background template. Thus it is contemplated that the body-mounted threat detection system can be operated without obtaining a background template and/or without subtracting the background template from the return signal.

In some embodiments, suitable transformations are carried out on the reflected and/or re-radiated electromagnetic signal (i.e. the return signal) prior to subtracting the background template and/or comparing the return signal to the plurality of predetermined safe templates and/or threat templates. For example and without limitation, Fourier transforms may be conducted, statistical analyses including average differences and standard deviations may be carried out, the signal may be converted to a digital form, and so on.

In some embodiments, artificial intelligence, a neural network, or machine learning is used to carry out signal processing at step 30. In some embodiments, new safe templates and/or new threat templates can be added to the library or database of predefined safe and threat templates as additional data is acquired in the field. For example, once a user of the body-mounted threat detection system has confirmed that a target is carrying a weapon or other threat object, the user can provide feedback to the system to confirm that a threat object has been detected. Alternatively, once a user of the body-mounted threat detection system has confirmed that a target is not carrying a weapon or other threat object, the user can provide feedback to the system to confirm that no threat object has been detected, including if safe objects are present on the target person.

Based on the outcome of the signal processing conducted at step 30, at step 32, a threat assessment can be made. If the return signal obtained from the target matches one or more threat templates, then a threat warning, e.g. an audible signal such as a beep or a verbal warning, or a visible signal such as a coloured indicator light, e.g. a red light, or a textual warning displayed on an output screen, or a tactile warning, can be generated at step 34 so that the user of the body-mounted weapons detection system knows that the target represents a potential threat.

If the signal obtained from the target matches one or more safe templates and does not match any threat templates, then a different indication that is a safe indication, e.g. an audible tone or verbal indication different from that used to provide a threat warning or a visible signal such as a differently coloured indicator light, e.g. a green light, or a different textual message displayed on an output screen, or a different tactile indication, can be generated at step 36 so that the user of the body-mounted weapons detection system knows that the target is likely unarmed.

If the signal obtained from the target cannot be clearly identified as matching either a threat template or a safe template, then at step 38 a different indication that indicates uncertainty, e.g. an audible tone or verbal indication different from those used to provide a threat warning or a safe indication, or a visible signal such as a differently coloured indicator light, e.g. a yellow light, or a different textual message displayed on an output screen, or a different tactile indication, can be generated at step 38 so that the user of the body-mounted threat detection system knows that it cannot clearly be determined whether or not the target is carrying a weapon or other threat object.

In some embodiments, tactile feedback, e.g. a vibration or pulse that can be felt by a user of the body-mounted threat detection system, can be used instead of or in addition to audible or visible feedback at steps 34, 36 and/or 38.

In alternative embodiments, a visual indication of a probability or likelihood that the target is carrying one or more threat objects can be provided at steps 34, 36 and/or 38. For example, a threat warning at step 34 might indicate a 70%, 75%, 80%, 85%, 90%, 91%, 92%, 93%, 94%, 95%, 96%, 97%, 98%, 99%, 99.9% or higher likelihood that the target is carrying at least one threat object. A safe indication at step 36 might indicate a 30%, 25%, 20%, 15%, 10%, 9%, 8%, 7%, 6%, 5%, 4%, 3%, 2%, 1%, 0.1% or lower likelihood that the target is carrying at least one threat object. An uncertain indication at step 38 might indicate a likelihood between 30% and 70%, or between any other desired confidence interval including a range defined by any combination of the values set forth above, that the target is carrying at least one threat object.

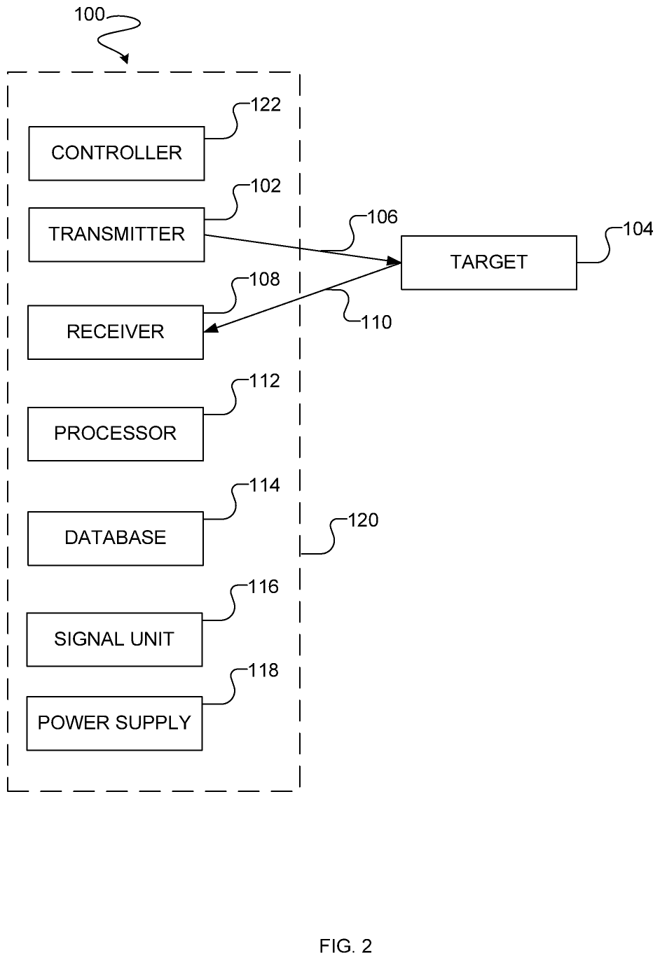

With reference to FIG. 2, an example embodiment of a body-mounted threat detection system 100 capable of carrying out method 20 is illustrated. Body-mounted threat detection system 100 has a body-worn transmitter 102 for directing electromagnetic radiation towards a target 104, for example a person who may be carrying a weapon, explosive, or other threat object, as indicated by arrow 106. In some embodiments, body-worn transmitter 102 is a body-mounted antenna.

Body-mounted threat detection system 100 also has a body-mounted receiver 108 that is configured to receive electromagnetic radiation that is returned by target 104 (e.g. reflected off or re-radiated by target 104), as indicated by arrow 110 indicating the return signal. In some embodiments, body-mounted receiver 108 is a body-mounted antenna.

Body-mounted threat detection system 100 further includes a processor 112 for processing the reflected and/or re-radiated signals 110 from target 104, a database 114 or other storage system for storing data for comparison to the electromagnetic radiation that is reflected from and/or re-radiated by target 104, a signal unit 116 for outputting an indication of whether or not a threat has been detected, and a power supply 118, for example a rechargeable battery pack, for powering the components of body-mounted threat detection system 100.

In some embodiments, processor 112 and database 114 are provided as part of an on-board computer that is built into body-mounted threat detection system 100. In some embodiments, processor 112, database 114, and signal unit 116 are provided as part of an on-board computer that is built into body-mounted threat detection system 100.

As indicated schematically by box 120, in the illustrated embodiment, all of transmitter 102, receiver 108, processor 112, database 114, signal unit 116, and power supply 118 are provided to be worn on the body of a user of body-mounted threat detection system 100. In this way, body-mounted threat detection system 100 is a self-contained portable unit that can be worn by a user without significantly interfering with the user's mobility or comfort.

In some embodiments, signal unit 116 may be provided as part of a visual display unit worn by a user, e.g. a heads-up display, suitable glasses worn by a user as an optical head-mounted display, night vision goggles worn by the user, or the like, to make it easy for the user to see the output provided by body-mounted threat detection system 100. In some embodiments, two signal units 116 are provided, one signal unit 116 that is part of a visual display unit that can be optionally worn by the user and one signal unit 116 that is mounted elsewhere on a user's body, e.g. that is part of a tactical vest, shirt, jacket or other structure worn by the user to support the other components of system 100.

In some embodiments, a controller 122 is further provided on the body-mounted portion of body-mounted threat detection system 100, to control the operation of transmitter 102 and receiver 108. In embodiments in which transmitter 102 and receiver 108 are both body-mounted antennas, controller 122 controls both of the body-mounted antennas 102, 108 provided on body-mounted threat detection system 100.

In some embodiments, a plurality of transmitters 102 and/or a plurality of receivers 108 are provided on body-mounted threat detection system 100. For example, in embodiments in which transmitter 102 and receiver 108 are both body-mounted antennas, a plurality of body-mounted antennas (e.g. 2, 3, 4, 5, 6, 7, 8, 9, 10 or more) can be provided as a plurality of transmitters 102, and a plurality of body-mounted antennas (e.g. 2, 3, 4, 5, 6, 7, 8, 9, 10 or more) can be provided as a plurality of receivers 108.

In alternative embodiments, certain components of body-mounted threat detection system 100 could be provided at locations distant to the body of the user represented by box 120.

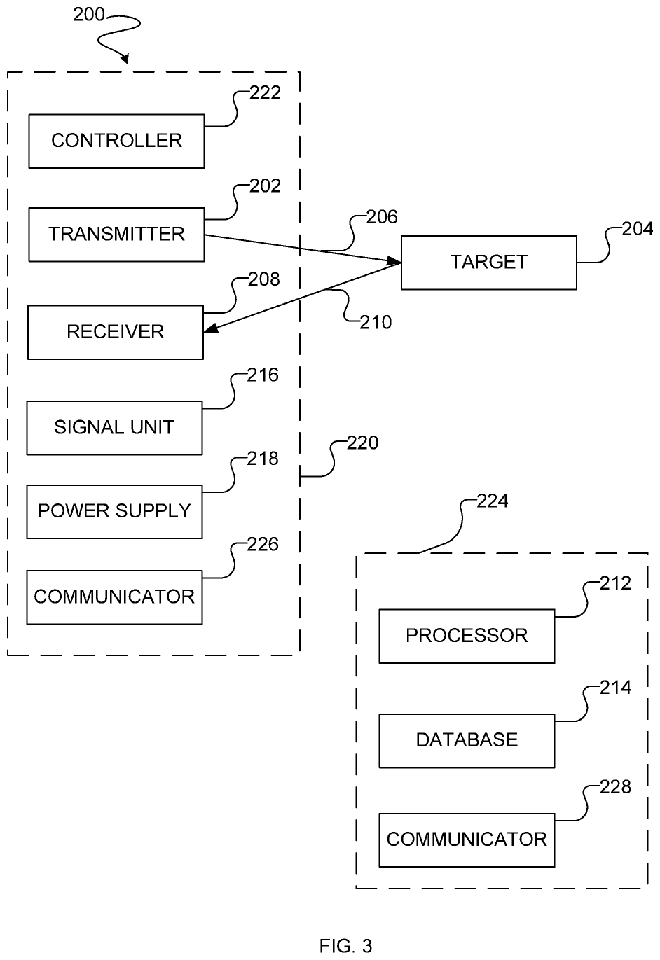

For example, as shown in FIG. 3 in which reference numerals referring to like components have been incremented by 100, processor 212 and database 214 could be provided at a remote location, indicated schematically by box 224. In such embodiment, data received by receiver 208 could be transmitted to that remote location 224 for processing and analysis by a suitable communicator 226 provided on body-mounted threat detection system 200 with transmit/receive functionality.

Data transmitted from body-mounted threat detection system 200 by communicator 226 to remote location 224 could be received by a corresponding communicator 228 with transmit/receive functionality provided at remote location 224 and passed to processor 212 for analysis. After the analysis is completed by processor 212 at the remote location 224, a result of a threat assessment could be generated by processor 212 at the remote location 224 and transmitted back to communicator 226 on body-mounted threat detection system 200 by communicator 228 so that signal unit 216 can be appropriately activated to display a threat assessment indication to the user of system 200.

In such embodiments, communicators 226, 228 can be provided by any suitable communications interface unit able to communicate with other devices in any suitable wireless manner, e.g. using Bluetooth or WiFi technology.

In one example embodiment, box 120 (or box 220) represents a utility vest on which all of the components of body-mounted threat detection system 100 (or 200) are mounted or stitched. In some embodiments, the utility vest represented by box 120 (or box 220) is a bulletproof vest similar to those conventionally worn by military or law enforcement personnel. In another example embodiment, box 120 (or box 220) represents a jacket on which all of the components of body-mounted threat detection system 100 (or 200) are mounted or stitched. In another example embodiment, box 120 (or box 220) represents a shirt on which all of the components of body-mounted threat detection system 100 (or 200) are mounted or stitched.

In some embodiments, database 114 contains a library of predetermined safe templates and predetermined threat templates to which the reflected and/or re-radiated signals 110 from target 104 are compared.

In some embodiments, signal unit 116 is configured to output a visual indication that a threat has been detected on target 104. For example, signal unit 116 may be provided with a plurality of indicator lights of different colours in a position that can be easily visually observed by a user of system 100, e.g.
a red indicator light that is illuminated if a threat is detected if the processor 112 determines that the target 104 matches one or more threat templates;
a green indicator light that is illuminated if the processor 112 determines that the target 104 matches one or more safe templates and no threat templates; or
a yellow indicator light that is illuminated if the processor 112 cannot determine whether a threat is present on target 104 (for example, if reflected and/or re-radiated signals 110 do not match any safe templates or any threat templates).

In alternative embodiments, rather than illuminating coloured indicator lights, signal unit 116 may display a brief text message on a visual display to confirm the determined status of target 104, e.g. “THREAT”, “SAFE” or “UNKNOWN”.

In some embodiments, signal unit 116 is configured to output an audible indication that a threat has been detected on target 104. For example, signal unit 116 may output a first audible tone or beep if a threat is detected, a second and different audible tone or beep if it is determined that the target 104 matches one or more safe templates and no threat templates, or a third and different audible tone or beep if processor 112 cannot determine whether a threat is present on target 104. In alternative embodiments, rather than an audible tone or beep, signal unit 116 may provide a verbal indication of the status of target 104 that has been determined by processor 112, e.g. by audibly indicating “THREAT”, “SAFE” or “UNKNOWN”.

In some embodiments, signal unit 116 is configured to output a tactile indication that a threat has been detected on target 104, for example by causing a vibration that can be perceived by a user wearing body-mounted threat detection system 100. In some embodiments, a first type of tactile feedback, e.g. a type of vibration, e.g. a steady vibration lasting for about one second, could be used to indicate that a threat has been detected, a second type of tactile feedback, e.g. a type of vibration, e.g. two short vibrations each lasting about one quarter of a second could be used to indicate that the status of target 104 is unknown, and a third type of tactile feedback, e.g. no vibration or one short vibration lasting about one quarter of a second, could be provided to indicate that the status of target 104 is safe.

In some embodiments, body-mounted threat detection system 100 is configured to determine the nature of the threat object carried by the target 104, e.g. by determining whether the threat object is a gun, a knife, or an explosive device. To do so, database 114 can be provided with a plurality of different threat templates that have been categorized as to the type of threat object present, e.g. gun, knife or explosive device. Processor 112 can then determine based on the characteristics of the return signal 110 as compared with the plurality of specific threat templates the nature of the threat object present on target 104.

In some such embodiments, signal unit 116 of body-mounted threat detection system 100 is configured to provide to the user an output corresponding to the nature of the threat object carried by the target 104. For example, signal unit 116 can provide a visible or audible indication of the nature of the threat object as determined by processor 112, e.g. by displaying or speaking a word describing the nature of the threat object, e.g. “GUN”, “KNIFE”, “EXPLOSIVE”, or by illuminating a suitable indicator light labelled to confirm the nature of the threat object carried by the target 104.

In some situations, a change in the orientation of the target 104 with respect to body-mounted threat detection system 100 may change the profile or characteristics of the reflected and/or re-radiated signals 110 received from target 104. Thus, in some situations where the processor 112 is not able to confirm the status of target 104 after a first cycle of operation, processor 112 may be able to confirm the status of target 104 after a further cycle of operation once the target 104 has shifted in position relative to the user of body-mounted threat detection system 100.

In some embodiments, body-mounted threat detection system 100 is operated on a continuous cycle, so that the status of the target 104 is determined repeatedly several times. In some embodiments, body-mounted threat detection system 100 operates continuously until a target 104 has been determined to have a threat status, at which point body-mounted weapons detection system 100 stops cycling to allow the threat to be dealt with.

In some embodiments, body-mounted threat detection system 100 is activated only at the request of a user of the system, for example by the user pushing a button to activate the body-mounted threat detection system 100. Body-mounted threat detection system 100 would cycle once after being activated by the user, provide an output via signal unit 116, and then remain inactive until the next time that a user activated the system. In some embodiments, where body-mounted threat detection system 100 indicates that the status of a target 104 is unknown, the user of the system 100 may cause the target 104 to adjust his or her position relative to the user (e.g. by verbally commanding the target 104 to rotate by) 90°, or the user of the system may wait until the position of target 104 has shifted relative to the user before activating body-mounted threat detection system 100 for a further cycle.

In some embodiments, a plurality of different body-mounted threat detection systems 100 may be equipped with suitable communication units (e.g. including transmitters and receivers) to allow communication between the plurality of body-mounted threat detection systems 100. In some such embodiments, if two or more users of body-mounted threat detection system 100 are focussed on the same target of interest, the two or more body-mounted threat detection systems 100 may communicate between themselves to compare reflected and/or re-radiated signals obtained from the target of interest at different angles. In some circumstances, having data relating to a single target of interest but obtained at different angles may increase the reliability and/or accuracy of the detection of a threat by body-mounted threat detection system 100.

While an example embodiment of a body-mounted weapons detection system and methods of using a body-mounted weapons detection system have been described above, in alternative embodiments, rather than being body-mounted, the various components described above could be mounted in or to a dedicated portable unit that could be carried by a user and used to remotely detect a weapon, explosive or other threat item.

In some embodiments, suitable storage media are provided that contain all of the information, threat templates, and safe templates needed to operate a body-mounted weapons detection system.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A body-mounted threat detection system for allowing a user of the system to detect threat objects on a target, the system comprising:
a body-mounted transmitter for directing electromagnetic radiation towards the target;
a body-mounted receiver for receiving elect magnetic radiation returned from the target as a return signal;
a database comprising a plurality of predetermined t plates representing return signals for a plurality of different known threat items;
a processor adapted to analyze the return signal by comparing the return signal with the plurality of predetermined threat templates; and
a signal unit configured to output a threat indication the processor determines that the return signal matches one or more of the predetermined threat templates.

2. A body-mounted threat detection system as defined in claim 1, wherein the database further comprises a plurality of predetermined safe templates representing return signals for a plurality of different known safe items, and wherein the processor is further configured to analyze the return signal by comparing the return signal with the plurality of predetermined safe templates.

3. A body-mounted threat detection system as defined in claim 2, wherein the signal unit is configured to output a safe indication if the processor determines that the return signal matches one or more of the predetermined safe templates and none of the predetermined threat templates.

4. A body-mounted threat detection system as defined in claim 1, wherein the signal unit is configured to output an unknown signal if the signal unit determines that the return signal matches none of the predetermined safe templates and none of the predetermined threat templates.

5. A body-mounted threat detection system as defined in claim 1, wherein the plurality of predetermined threat templates include a plurality: of threat templates for guns, knives and explosives, wherein the processor is configured to make a determination of whether the return signal matches at least one of the plurality of threat templates for guns, knives or explosives.

6. A body-mounted threat detection system as defined in claim 5, wherein the signal unit is configured to output an indication that:
the threat object is a gun if the processor determines that the return signal matches at east one of the plurality of threat templates for guns;
the threat object is a knife if the processor determines that the return signal matches at east one of the plurality of threat templates for knives; or
the threat object is an explosive if the processor determines that the return signal matches at least one of the plurality of threat templates for explosives.

7. (canceled)

8. (canceled)

9. (canceled)

10. (canceled)

11. (canceled)

12. A body-mounted threat detection system as defined in claim 1, wherein the body-mounted transmitter comprises one or more body-mounted antennas.

13. A body-mounted threat detection system as defined in claim 1, wherein the body-mounted receiver comprises one or more body-mounted antennas.

14. A method of allowing a user to detect a threat object on a target comprising:
transmitting electromagnetic radiation towards the target from a transmitter worn on the body of the user;
receiving electromagnetic radiation returned from the target as a return signal using a receiver worn on the body of the user;
comparing the return signal with a plurality of predetermined threat templates representing return signals for a plurality of different known threat items; and
outputting to the user a threat indication if the return signal matches one or more of the predetermined threat templates.

15. A method as defined in claim 14, further comprising comparing the return signal with a plurality of predetermined safe templates representing return signals for a plurality of different known safe items.

16. A method as defined in claim 15, comprising outputting to the user a safe indication if the return signal matches one or more of the predetermined safe templates and none of the predetermined threat templates.

17. A method as defined in claim 14, comprising outputting to the user an unknown indication if the return signal matches none of the predetermined safe templates and none of the predetermined threat templates.

18. A method as defined in claim 14, wherein the step of comparing the return signal with a plurality of predetermined threat templates comprises comparing the return signal with a plurality of threat templates for guns, knives and explosives, and wherein the step of outputting to the user a threat indication comprises:
if the return signal matches at least one of the plurality of threat templates for guns, outputting to the user an indication that the threat object is a gun;
if the return signal matches at least one of the plurality of threat templates for knives, outputting to the user an indication that the threat object is a knife; and
if the return signal matches at least one of the plurality of threat templates for explosives, outputting to the user an indication that the threat object is an explosive.

19. (canceled)

20. (canceled)

21. A computer readable medium having stored thereon instructions that, when executed by a computer, cause the computer to carry out the method as defined in claim 14.

22. (canceled)

23. (canceled)

24. (canceled)

25. (canceled)

26. A body-mounted threat detection system or a method as defined in claim 1, wherein the electromagnetic radiation comprises microwaves.

27. A body-mounted threat detection system or a method as defined in claim 1, wherein the electromagnetic radiation has a frequency in the range of 300 MHz to 300 GHz.

28. A body-mounted threat detection system or a method as defined in claim 1, wherein the electromagnetic radiation has a wavelength in the range of 0.1 cm to 100 cm.

29. A body-mounted threat detection system or a method as defined in claim 1, wherein the electromagnetic radiation is polarized.

30. A body-mounted threat detection system or a method as defined in claim 1, wherein the electromagnetic radiation comprises a stepped frequency pulse.

31. A body-mounted threat detection system or a method as defined in claim 1, wherein the electromagnetic radiation comprises a wide-band pulse.
